(19) United States
(12) Patent Application Publication
(10) Pub. No.: US 2010/0049787 A1
(43) Pub. Date: Feb. 25, 2010

(54) Method of an internet service, system and data server therefor

(75) Inventors: Chieh-Chih Tsai, Taipei (TW); Yung-sen Lin, Taipei (TW); Chuan-Ming Tsai, Taipei (TW)

Correspondence Address: OLIFF & BERRIDGE, PLC, P.O. BOX 320850, ALEXANDRIA, VA, 22320-4850, US

(73) Assignee: ACER INCORPORATED, Taipei Hsien (TW)

(21) Appl. No.: 12/453,877

(22) Filed: May 26, 2009

(30) Foreign Application Priority Data
Aug. 21, 2008 (TW) 097131920

(51) Int. Cl. G06F 15/173

(52) U.S. Cl. 709/203

(57) ABSTRACT

In a method of an internet service, a user inputs a request at a wireless communication terminal device, so as to receive via a data server web contents and data contents provided by a community server over the Internet. The data server selectively re-arranges the layout of the web contents and at least one resolution, compression ratio or the number of color of the multimedia data according to a level of closeness between the user, object owners and the data contents contained in the web contents or the data contents. The re-layout web contents and the re-arranged multimedia data are sent to the wireless communication terminal device for the user to efficiently watch information in connection with his or her friends when browsing the community website or the web page on the wireless communication terminal device. An internet service system and a data server for implementing the method are also provided.

### FIELD OF THE INVENTION

The present invention relates to a method of an internet service, and a system and a data server therefore, and more particularly to a technical field of dynamically adjusting a community web page.

### BACKGROUND OF THE INVENTION

Presently, portable Internet devices, such as smart cell phones or personal digital assistants (PDAs), are more and more convenient for use, and many users have gradually got used to surfing web pages via the portable Internet devices in order to know the newest information in real time. However, the portable Internet device has a screen much smaller than a computer screen, and has lower bandwidth. Many web pages are designed for surfing on the computer screen. Therefore, the user is usually unable to view the complete web contents on the small screen of the portable Internet device, but has to frequently drag scrollbars to scroll the web page. In addition, if the web page content contains high-resolution multimedia data, users must wait for a longer transmission time, it makes the users can not smoothly surf the web page.

A community website allows users to share their personal information and make friends with one another, and is characterized in those contents shown on the web page can be set to different friendship levels. That is, a content owner can set the contents to be accessed only by his or her good friends but not other people. When the user uses the portable Internet device, one important object is to surf the contents in the community website. Therefore, what is needed is to make the user to efficiently surf web contents of a community website via the portable Internet device.

### SUMMARY OF THE INVENTION

A primary object of the present invention is to provide a method of an internet service, and a system and a data server therefore, so that a user can efficiently surf the contents of a community website via a wireless communication terminal device.

Another object of the present invention is to provide a method of a re-layout of web contents of an internet service of a community server over the Internet, applicable to a wireless communication terminal device for web surfing of a user. The method of a web content re-layout according to the present invention comprises the following steps. A request is sent out by the wireless communication terminal device and then is transmitted to a data server via a wireless communication network, and thereby the wireless communication terminal device is connected to the community server via the data server. User's friend information stored in the wireless communication terminal device is acquired and web contents corresponding to the request are downloaded from the community server by the data server. The web contents corresponding to the request comprise at least one object and friend information of the owner of the at least one object. A level of closeness between the user and the object owner is determined according to the user's friend information and the friend information of the object owner. Next, the data server selectively re-arranges the layout of the web contents corresponding to the request according to the level of closeness and the re-layout web contents are sent to the wireless communication terminal device.

Preferably, the object is disposed at an eye-catching location in the layout of the web contents, such as at an upper or a left part of the layout of the web contents, or a location that is more easily observed on a screen of the wireless communication terminal device while the user and the object owner have a closer relationship.

A further object of the present invention is to provide a web content re-layout of an internet service system for a user to efficiently surf web contents of a community server. The web content re-layout system according to the present invention comprises a data server and a wireless communication terminal device. The data server is coupled to the community server. The wireless communication terminal device allows the user to input a request thereat and sends the request to the data server via a wireless communication network, and thereby the wireless communication terminal device is linked to the community server via the data server. The wireless communication terminal device also sends user's friend information to the data server. When the data server downloads from the community server the web contents corresponding to the request, which includes at least one object and the friend information of the owner of the at least one object, a level of closeness between the user and the object owner is determined according to the user's friend information and the friend information of the object owner. The data server then selectively re-arranges the layout of the web contents corresponding to the request according to the level of closeness, and sends the re-layout web contents corresponding to the request to the wireless communication terminal device.

Preferably, the object is disposed at an eye-catching location in the layout of the web contents, such as at an upper or a left part of the layout of the web contents, or a location that is more easily observed on a screen of the wireless communication terminal device while the user and the object owner have a closer relationship.

A still further object of the present invention is to provide a data server, which is connected to a wireless communication network for a wireless communication terminal device to receive web contents provided by a community server via the data server. The data server comprises a receiving unit and a re-layout unit. The receiving unit receives user's friend information stored in the wireless communication terminal device. The re-layout unit receives the web contents provided by the community server, and the web contents include at least one object and friend information of the owner of the at least one object. The re-layout unit determines a level of closeness between the user and the object owner according to the user's friend information and the friend information of the object owner, and selectively re-arranges the layout of the received web contents based on an equipment parameter of the wireless communication terminal device and the level of closeness.

Preferably, the object is disposed at an eye-catching location in the layout of the web contents, such as at an upper or a left part of the layout of the web contents, or a location that is more easily observed on a screen of the wireless communication terminal device while the user and the object owner have a closer relationship.

Another object of the present invention is to provide a method of internet services of a community server over the Internet, applicable to a wireless communication terminal device for receiving the data of a user. The method of an internet services according to the present invention comprises the following steps. A request is sent out by the wireless communication terminal device and then is transmitted to a data server via a wireless communication network, and thereby the wireless communication terminal device is connected to the community server via the data server. The user's friend information stored in the wireless communication terminal device and is acquired a level of closeness between the user and the owner is determined according to the user's friend information and the friend information of the owner. The data server then selectively re-arranges at least one resolution, the number of color or compression ratio of the multimedia data of the data contents based on the equipment parameter and a level of closeness, and sends the data contents corresponding to the request to the wireless communication terminal device.

Preferably, the equipment parameter comprises the screen resolution or the number of color of the wireless communication terminal device.

A further object of the present invention is to provide a internet service system for a user to efficiently surf data contents of a community server. The internet service system according to the present invention comprises a data server and a wireless communication terminal device. The data server is coupled to the community server. The wireless communication terminal device allows the user to input a request thereat and sends the request to the data server via a wireless communication network, and thereby the wireless communication terminal device is linked to the community server via the data server. The wireless communication terminal device also sends user's friend information and an equipment parameter to the data server. When the data server downloads from the community server the data contents corresponding to the request, which includes at least one the friend information of the owner, a level of closeness between the user and the owner is determined according to the user's friend information and the friend information of the owner. The data server then selectively re-arranges at least one resolution, the number of color or compression ratio of the multimedia data of the data contents based on the equipment parameter and a level of closeness, and sends the data contents corresponding to the request to the wireless communication terminal device.

Preferably, the equipment parameter comprises resolution or the number of color of the screen of the wireless communication terminal device.

A still further object of the present invention is to provide a data server, which is connected to a wireless communication network for a wireless communication terminal device to receive data contents provided by a community server via the data server. The data server comprises a receiving unit and a multimedia processing unit. The receiving unit receives data contents stored in the communication web server, and the data contents comprise at least one friend information of the owner and an equipment parameter. A level of closeness between the user and the owner is determined according to the user's friend information and the friend information of the owner, the data server selectively re-arranging at least one resolution, compression ratio or the number of color of the multimedia data of the data contents according to the level of closeness.

Preferably, the equipment parameter comprises resolution or the number of color of the screen of the wireless communication terminal device.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a block diagram of a web content re-layout of an internet service system according to the present invention;

FIG. 2 is a block diagram of a web content re-layout of an internet service system according to an embodiment of the present invention;

FIG. 3 shows a schematic drawing of a first example of re-arranging the layout of web contents of an internet service system by a data server according to the present invention;

FIG. 4 shows a schematic drawing of a second example of re-arranging the layout of web contents of internet service by a data server according to the present invention;

FIG. 5 is a flowchart showing a method of an internet service according to the present invention;

FIG. 6 is a flowchart showing a method of an internet service according to an embodiment of the present invention.

FIG. 7 is a block diagram of an internet service system according to the present invention;

FIG. 8 is a block diagram of an internet service system according to an embodiment of the present invention;

FIG. 9 shows a schematic drawing of re-arranging the multimedia data according to the present invention;

FIG. 10 is a flowchart showing a method of an internet service according to the present invention; and

FIG. 11 is a flowchart showing a method of an internet service according to the present invention.

### DETAILED DESCRIPTION OF THE PREFERRED EMBODIMENTS

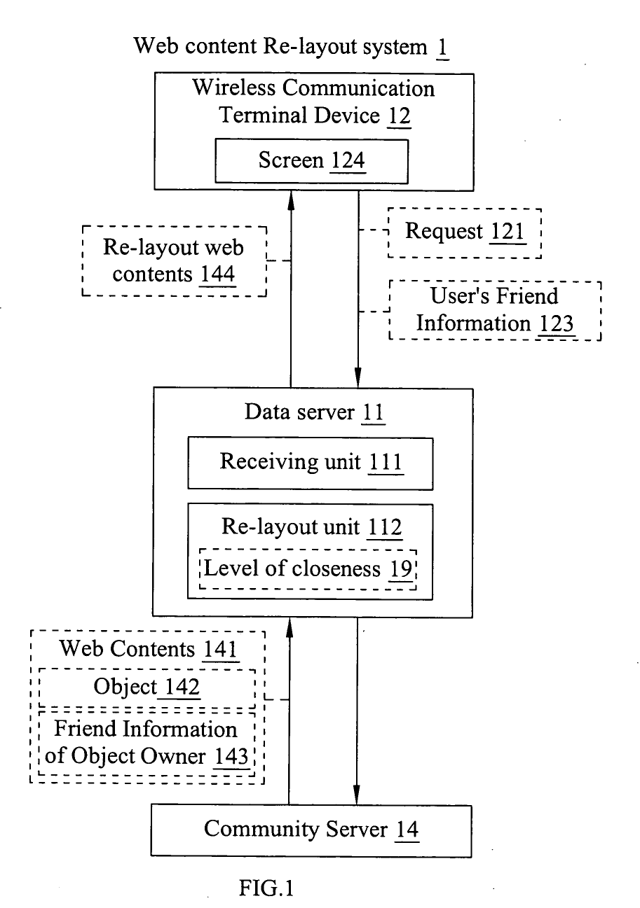

Please refer to FIG. 1 that is a block diagram of a web content re-layout of an internet service system according to the present invention. As shown, the web content re-layout system 1 includes a data server 11 and a wireless communication terminal device 12. The data server 11 comprises a receiving unit 111 and a re-layout unit 112. Preferably, the data server 11 is coupled between a Serving GPRS (General Packet Radio Service) Support Node (SGSN) and a Gateway GPRS Support Node (GGSN). The receiving unit 111 preferably comprises a network interface and a communication port. The wireless communication terminal device 12 allows a user to input a request 121 thereat. The request 121 is then sent out to the data server 11 via a wireless communication network. After receiving the request 121 via the receiving unit 111 thereof, the data server 11 is coupled to a community server 14. The request 121 can be a logon request or a data download request. In the event the wireless communication terminal device 12 has not yet logged on the community server 14, the data server 11 will send user identification information to the community server 14 to complete the logon procedure.

The wireless communication terminal device 12 also sends user's friend information 123 to the data server 11. The user's friend information 123 comprises a list of the user's good friends. After finishing the logon procedure, the data server 11 can download the user's friend information 123 from the community server 14.

The data server 11 downloads web contents 141 corresponding to the request 121 from the community sever 14, and the web contents 141 corresponding to the request 121 comprises at least one object 142 and friend information 143 of the owner of the at least one object 142, for example, a friend list of the object owner. The object 142 can be text data, multimedia data, or an application program. Generally, the web page of most community websites is designed to meet the screen size of a desktop or a notebook computer. However, the wireless communication terminal device 12 has a screen 124 usually smaller than computer screens in size. Therefore, for the user to surf the desired community website on the wireless communication terminal device 12 with better surfing quality, the data server 11 will re-arrange the layout of the web content 141, allowing the user surfing the web contents 141 on the screen 124 of the wireless communication terminal device 12 to see at the first sight the content that is most interesting to or most concerned by the user.

The re-layout unit 112 determines a level of closeness 19 between the user and the object owner according to the user's friend information 123 and the friend information 143 of the object owner. Generally speaking, when surfing a community web page, the user is more interested in and desires to read first materials in connection with his or her closer friends, and does not mind skipping materials in connection with other less-close friends. Therefore, the re-layout unit 112 will follow the level of closeness 19 to selectively re-arrange the layout of the web contents 141 corresponding to the request 121, such as changing the display locations of some objects in the web page, as shown in the following Table 1:

TABLE 1

| | Relation Closeness | Object Display Location |
|---|---|---|
| Closer | The object owner is a | The object is moved and |
| Relationship | friend of the user | disposed at a location |
| ↑ | | closer to an upper or a left |
| \| | | part of the layout of web |
| \| | | contents |
| \| | The object owner is not a | The object is remained at |
| \| | friend of the user but a | the same location |
| \| | friend of a friend of | |
| ↓ | the user | |
| Less-close | The object owner is neither | The object is moved and |
| Relationship | a friend of the user | disposed at a location |
| | nor a friend of a friend of | closer to a lower or a right |
| | the user | part of the layout of web |
| | | contents |

In the case the object owner is a friend of the user, it represents the object owner and the user are relatively close with each other, and the user is supposed to be more interested in the object 142 and desires to view the friend's object as soon as the wireless communication terminal device 12 is linked to the community server 14 to download the community web page without the need of searching the web page by dragging scrollbars. Therefore, the object 142 is moved and disposed at an eye-catching location in the layout of the web contents 141 or a location that can be more easily observed on the screen 124.

In the case the object owner is not a friend of the user but a friend of a friend of the user, it represents the object owner and the user are not acquainted with each other but have a common friend. Therefore, the object 142 is remained at the same location in the web contents 141, or is moved later only when the layout of the web contents 141 in connection with the user's friend has been determined in location. Or, in the case object owner is neither a friend of the user nor a friend of a friend of the user, it represents the object owner and the user are not familiar or in close relationship with each other. Therefore, the object 142 owned by such owner is moved to a less eye-catching location in the layout of the web contents 141 or to a location less easily observable on the screen 124.

Further, the receiving unit 111 can also receive an equipment parameter of the wireless communication terminal device 12. Depending on actual need, the re-layout unit 112 can properly re-arrange the layout of the web contents 141 corresponding to the request 121 based on both of the equipment parameter and the level of closeness 19 between the user and the object owner. Preferably, the equipment parameter records the resolution of the screen 124 of the wireless communication terminal device 12.

Thereafter, the data server 11 sends the re-layout web contents 144 to the wireless communication terminal device 12 for the user to surf on the screen 124. Depending on actual need, the data server 11 can further comprise a filter for filtering the web contents 141 to delete unnecessary materials, such as extremely small pictures, advertising images, etc., so as to further decrease the quantity of the web contents 141. Moreover, it is understood the adjustment of the object location corresponding to the level of closeness as described in the above Table 1 is only for exemplification and not intended to restrict the present invention. Therefore, so long as an adjustment enables an object at a more eye-catching location on a web page or at a location that can be more easily observed on the screen 124 of the wireless communication terminal device 12 while the user and the object owner have a closer relationship, or enables an object at a less eye-catching location on a web page or at a location that is less easily observed on the screen 124 of the wireless communication terminal device 12 while the user and the object owner have a less-close relationship, such adjustment is within the protection scope of the present invention.

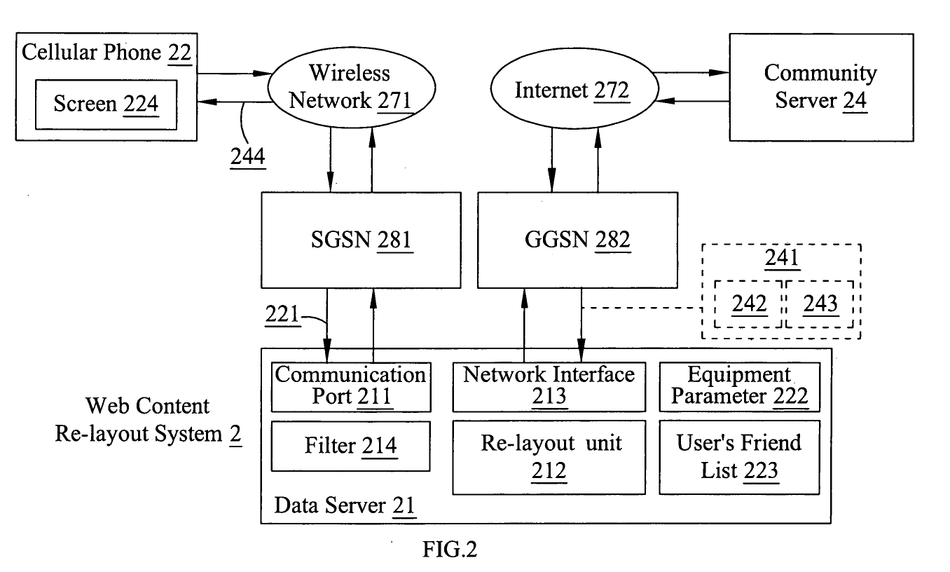

Please refer to FIG. 2, which is a block diagram of a web content re-layout of an internet service system 2 according to an embodiment of the present invention. As shown, the web content re-layout system 2 comprises a data server 21 and a cellular phone 22. The data server 21 comprises a communication port 211, a re-layout unit 212, a network interface 213, and a filter 214. The data server 21 is coupled between an SGSN 281 and a GGSN 282. When a user inputs an uniform resource locator (URL) of a community website at the cellular phone 22, the cellular phone 22 sends a link request 221 via a wireless network 271 and the SGSN 281 to the data server 21. After receiving the request 221 via the communication port 211, the data server 21 uses the network interface 213 to connect with a community server 24 corresponding to the URL of the request 221 over the Internet 272 via the GGSN 282. The data server 21 can acquire an equipment parameter 222 from the cellular phone 22. Or, the data server 21 can have internally built equipment parameter for a wide range of different types of cellular phones and search for an equipment parameter 222 corresponding to a model of the cellular phone 22 being used by the user. The equipment parameter 222 comprises the resolution of a screen 224 on the cellular phone 22. In addition, the data server 21 can acquire a user's friend list 223 from the cellular phone 22 or the community server 24.

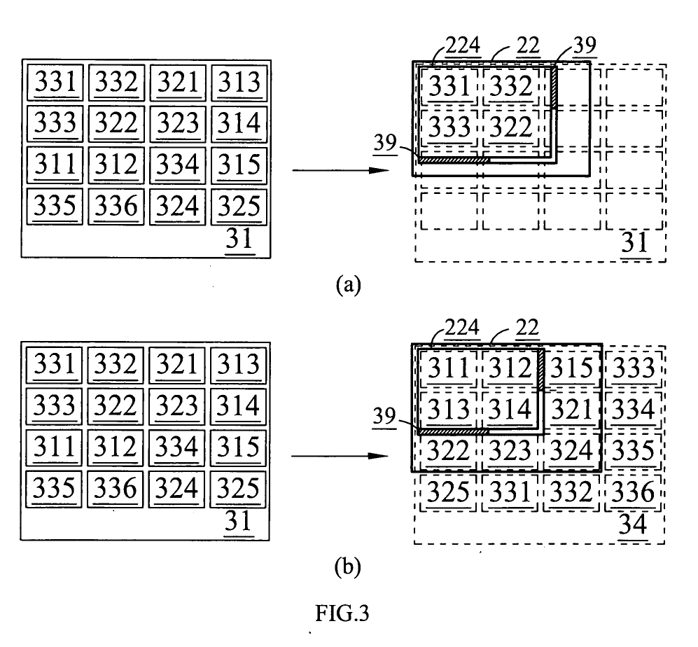

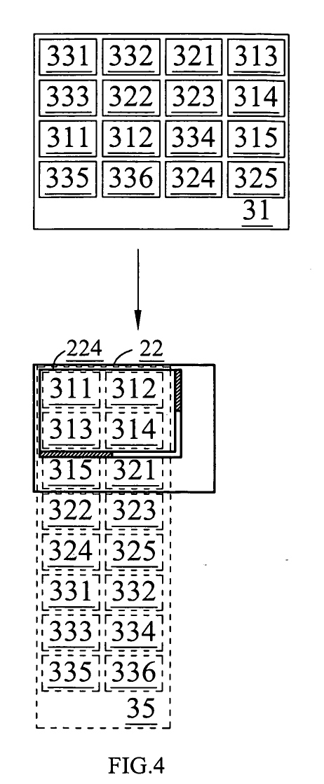

After the data server 21 downloads web contents 241 corresponding to the request 221 from the community server 24, the filter 214 can filter off some unnecessary content to effectively decrease the quantity of the web contents 241. Thereafter, according to a friend list 223 of the user and a friend list 243 of the owner of the object 242 contained in the web contents 241, the re-layout unit 212 determines a level of the closeness between the user and the object owner. Since the re-layout unit 212 determines the level of closeness between the user and the object owner in a manner similar to that as described in Table 1, it is not described in details herein. The re-layout unit 212 then re-arranges the layout of the web contents 241 according to the level of closeness or based on both of the level of closeness and the equipment parameter 222. Two examples of re-arranging layouts of web contents are shown in FIGS. 3 and 4. Finally, the data server 21 sends re-layout multimedia data 244 to the cellular phone 22 via the communication port 211.

FIG. 3 shows a schematic drawing of a first example of re-arranging the layout of web contents of an internet service system by the data server according to the present invention. As shown, the web contents 31 comprises objects 311˜315, 321˜325, and 331˜336. The objects 311˜315 are owned by persons who are good friends of the user; the objects 321˜325 are owned by persons who are not friends of the user but friends of friends of the user; and the objects 331˜336 are owned by persons who are neither friends of the user nor friends of friends of the user. Before the layout of the web contents 31 is re-arranged, the user surfing the web contents 31 on the screen 224 of the cellular phone 22 is not able to effectively surf the complete web page, and the objects 331˜333 and 322 that are least interesting to or concerned by the user will be disposed on the screen 224 first, as shown in FIG. 3(a). Under this condition, the user has to drag scrollbars 39 to search for the objects 311˜315 that are more interesting to the user. By doing this, a lot of time is wasted and increased cost for occupying additional bandwidth is required. To more clearly show the relationship between the web layout and the screen 224 of the cellular phone 22, the web contents 31 illustrated at the right side of FIG. 3(a) is indicated by dotted lines while the cellular phone 22 and the screen 224 are indicated by solid lines.

When the layout of the web contents 31 is re-arranged according to the level of closeness and downloaded to the cellular phone 22, as the re-layout web contents 34 shown at the right side of FIG. 3(b), the user can see at the first sight the objects 311˜314 that are most interesting to the user, and the object 315 can also be easily viewed simply by slightly dragging a scrollbar 39. And, it is very possible that the user downloads the web simply for watching the objects 311˜315. Therefore, when the objects 311˜315 have been watched, the user can stop downloading the web contents at any time to thereby save the use of the bandwidth and the cost therefore.

FIG. 4 shows a schematic drawing of a second example of re-arranging the layout of web contents of an internet service system by the data server according to the present invention. As shown, the layout of the web contents 31 is re-arranged according to the level of closeness between the user and the object owner, as well as the equipment parameter 222. According to the resolution of the screen 224 as indicated by the equipment parameter 222, the data server 21 determines that the screen 224 has a width sufficient for displaying two objects side by side at the same time. Therefore, the layout of the web contents 31 is re-arranged to show the objects in a longitudinal direction, as the re-layout web contents 35 shown at a lower part of FIG. 4, allowing the user to browse the re-layout web contents 35 simply by dragging a vertical scrollbar 39. It is noted the re-layout web contents in FIGS. 3 and 4 are illustrated only for exemplification and not intended to restrict the scope of the present invention.

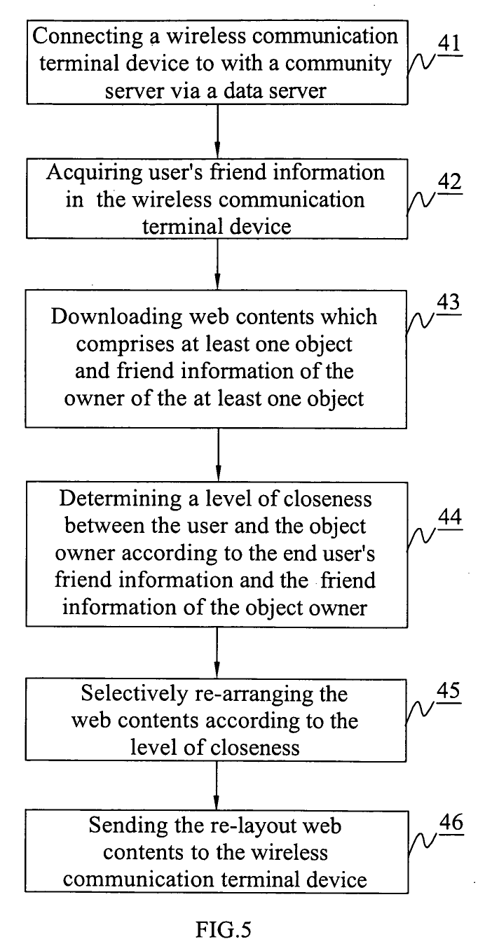

Please refer to FIG. 5, which is a flowchart showing a method of an internet service according to the present invention. The illustrated method allows a user to operate a wireless communication terminal device, such as a cellular phone or a personal digital assistant (PDA), to receive web contents of a community server over the Internet. The method comprises the following steps. In step 41, the user sends out a request at the wireless communication terminal device and the request is then transmitted to a data server via a wireless communication network, and thereby the wireless communication terminal device is connected to a community server over the Internet via the data server. In step 42, user's friend information stored in the wireless communication terminal device is acquired. In step 43, the data server downloads web contents corresponding to the request from the community server and the web contents corresponding to the request comprises at least one object and friend information of the owner of the at least one object. In step 44, a level of closeness between the user and the object owner is determined according to the user's friend information and the friend information of the object owner, as shown in Table 1. In step 45, according to the level of closeness, the data server selectively re-arranges the layout of the web contents corresponding to the request. Finally, in step 46, the re-layout web contents are sent to the wireless communication terminal device.

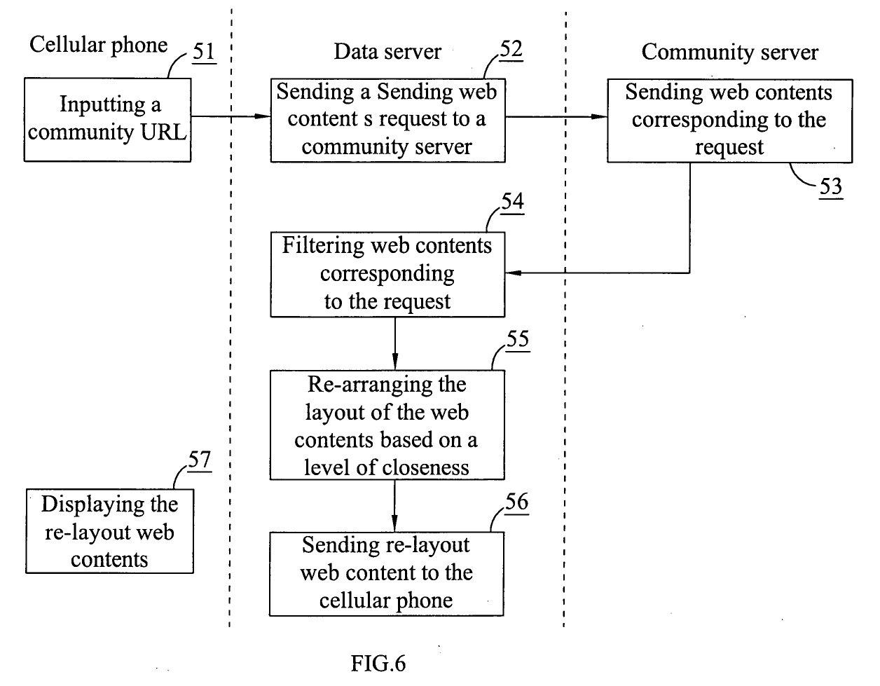

FIG. 6 is a flowchart showing a method of an internet service according to an embodiment of the present invention. In step 51, a user inputs a community URL at a cellular phone, and the request containing the community URL is transmitted to a data server via a wireless network. In step 52, after receiving the request, the data server sends a sending web content request to a community server corresponding to the requested community URL over the Internet. In the event the user has not yet logged on the requested community website, the data server can send a logon request to the community server and send user identification information to the community server to complete the logon procedure. In step 53, the community server sends web contents corresponding to the request to the data server. The web contents comprise at least one object and friend information of the object owner. In step 54, the data server filters the received web contents corresponding to the request, so as to filter off extremely small pictures or advertising contents. In step 55, according to the user's friend information and the friend information of the owner of the at least one object, a level of closeness between the user and the object owner is determined, as shown in Table 1, and the layout of the web contents corresponding to the request are re-arranged according to the level of closeness, as shown by the example in FIG. 3. If necessary, the layout of the web contents can be re-arranged according to both the level of closeness and an equipment parameter of the cellular phone, as shown by the example in FIG. 4. In step 56, the re-layout web contents are sent to the cellular phone. And, finally, in step 57, the re-layout web contents are displayed on a screen of the cellular phone.

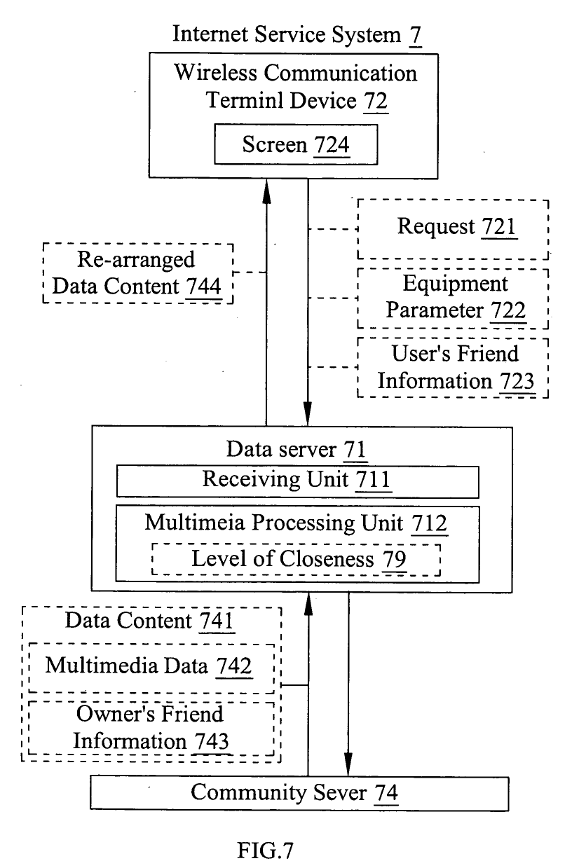

Please refer to FIG. 7 that is a block diagram of an internet service system according to the present invention. As shown, the internet service system 7 includes a data server 71 and a wireless communication terminal device 72. The data server 71 comprises a receiving unit 711 and a multimedia processing unit 712. Preferably, the data server 71 is coupled between a Serving GPRS (General Packet Radio Service) Support Node (SGSN) and a Gateway GPRS Support Node (GGSN). The receiving unit 711 preferably comprises a network interface and a communication port. The wireless communication terminal device 72 allows a user to input a request 721 thereat. The request 721 is then sent out to the data server 71 via a wireless communication network. After receiving the request 721 via the receiving unit 711 thereof, the data server 71 is coupled to a community server 74. The request 721 can be a logon request or a data download request. In the event the wireless communication terminal device 72 has not yet logged on the community server 74, the data server 71 will send user identification information to the community server 74 to complete the logon procedure.

The wireless communication terminal device 72 also sends an equipment parameter 722 and user's friend information 723 to the data server 71. The equipment parameter 722 comprises resolution or the number of color of the screen 724 of the wireless communication terminal device. The user's friend information 723 comprises a list of the user's good friends. After finishing the logon procedure, the data server 71 can download the user's friend information 723 from the community server 74.

The data server 71 downloads data contents 741 corresponding to the request 721 from the community sever 74, and the data contents 741 corresponding to the request 721 comprises at least one friend information 743 of the owner, for example, a friend list of the owner 741. Generally, the data content of most community websites is designed to meet the screen size of a desktop or a notebook computer and the default user has enough bandwidth to access to the multimedia data, such as pictures or audio-visual animation. However, the wireless communication terminal device 72 has a screen 724 usually smaller than computer screens in size and the bandwidth smaller than computer else. Therefore, for the user has better surfing quality on the wireless communication terminal device 72, the data server 71 will re-arrange at least one multimedia data 742 of the data content 741, allowing the multimedia data 742 displaying on the screen of the wireless communication terminal device 72 and transmitting in the smaller bandwidth.

The multimedia processing unit 712 determines a level of closeness 79 between the user and the owner of the data according to the user's friend information 723 and the friend information 743 of the owner. Generally speaking, when surfing a community web page, the user is more interested in and desires to read first materials in connection with his or her closer friends, and expects that the data can be more clarity. On the other hand, the user does not mind skipping materials in connection with other less-close friends. Therefore, the multimedia processing unit 712 will follow the level of closeness 79 and the equipment parameter 722 to selectively re-arrange the resolution, the compression ratio or the number of colors of at least one multimedia data of the data contents 741 corresponding to the request, as shown in the following Table 2:

TABLE 2

| | | | Compression |
|---|---|---|---|
| | | Resolution of | ration of the |
| | | the multimedia | multimedia |
| | Relation Closeness | data | data |
| Closer | The owner is a friend of | To maintain the | Low |
| Relationship | the user | original | compression |
| ↑ | | resolution | ratio |
| \| | The owner is not a friend | Reduce the | Middle |
| \| | of the user but a friend of | resolution of | compression |
| ↓ | a friend of the user | 50% | ratio |
| Less-close | The owner is neither a | Reduce the | High |
| Relationship | friend of the user nor a | resolution of | compression |
| | friend of a friend of the | 25% | ratio |
| | user | | |

In the case the owner is a friend of the user, it represents the owner and the user are relatively close with each other, and the user is supposed to be more interested in the multimedia data 742 and desires to view a clearer picture or video. Therefore, the multimedia processing unit 712 maintain the resolution of the multimedia data 742 and use lower compression ratio to compress the multimedia data 742 for maintaining the clarity of the multimedia data 742.

In the case the owner is not a friend of the user but a friend of a friend of the user, it represents the object owner and the user are not acquainted with each other but have a common friend. Therefore, the multimedia processing unit 712 moderately reducing resolution of the multimedia data 742, for example, its resolution will be reduced to 50%, to retain a larger display area to the user's friend's multimedia data. In addition, the multimedia processing unit 712 compress the multimedia data 742 of the owner by middle compression ratio for reducing the amount of data in order to retain a larger bandwidth to the user's friend's multimedia data.

Or, in the case owner is neither a friend of the user nor a friend of a friend of the user, it represents the owner and the user are not familiar or in close relationship with each other. Therefore, the multimedia processing unit 712 minimize the resolution of the owner's multimedia data 742, for example, its resolution will be reduced to 25%, and will be compressed by high compression ratio, so as to reduce the amount of data in order to retain a larger display regional and bandwidth to other users will be more interested in the multimedia data 742.

The multimedia processing unit 712 can also moderately reduce the resolution or the number of colors of the multimedia data 742 based on equipment parameter 722. The equipment parameter 722 records the screen resolution and the number of colors of the multimedia processing unit 712. Table 1 above as an example, if the resolution of the multimedia data 742 has 640 pixels×480 pixels, and the equipment parameter shows the screen resolution of the multimedia processing unit 712 only has 320 pixels×240 pixels. In order to let users can view the multimedia data 742 on the screen completely, the multimedia processing unit 712 reduce 640 pixels×480 pixels to 320 pixels×240 pixels in advance, and then, the multimedia processing unit 712 re-arrange the resolution of the multimedia data 742 to 320 pixels×240 pixels, 220 pixels×260 pixels or 160 pixels×120 pixels based on a level of closeness between the user and owners of the multimedia data 742. Similarly, the multimedia processing unit 712 also re-arranges the color number of the multimedia data 742 based on the screen color number of multimedia processing device 712 be recorded in the equipment parameter.

Thereafter, the data server 71 sends the re-arranged data contents 744 to the wireless communication terminal device 72 for the user to surf on the screen 724. Depending on actual need, the data server 71 can further comprise a filter for filtering the data contents 741 to delete unnecessary materials, such as extremely small pictures, advertising images, etc., so as to further decrease the quantity of the data contents 741. Moreover, it is understood the adjustment of the resolution and compression ratio corresponding to the level of closeness as described in the above Table 2 is only for exemplification and not intended to restrict the present invention. Therefore, so long as an adjustment enables an multimedia data has higher resolution and lower compression ratio while the user and the owner have a closer relationship, or enables an multimedia data has lower resolution and higher compression ratio while the user and the owner have a less-close relationship, such adjustment is within the protection scope of the present invention.

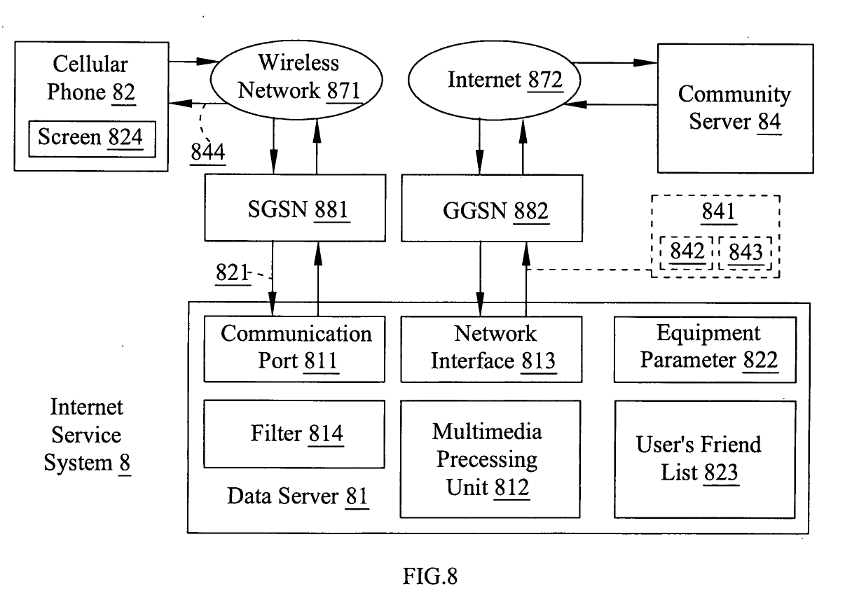

Please refer to FIG. 8, which is a block diagram of an internet service system according to an embodiment of the present invention. As shown, the internet service system 8 comprises a data server 81 and a cellular phone 82. The data server 81 comprises a communication port 811, a multimedia processing unit 812, a network interface 813, and a filter 814. The data server 81 is coupled between an SGSN 881 and a GGSN 882. When a user inputs a uniform resource locator (URL) of a community website at the cellular phone 82, the cellular phone 82 sends a link request 821 via a wireless network 871 and the SGSN 881 to the data server 81. After receiving the request 821 via the communication port 811, the data server 81 uses the network interface 813 to connect with a community server 84 corresponding to the URL of the request 821 over the Internet 872 via the GGSN 882. The data server 81 can acquire an equipment parameter 822 from the cellular phone 82. Another way, the data server 81 can have internally built equipment parameter for a wide range of different types of cellular phones and search for an equipment parameter 822 corresponding to a model of the cellular phone 82 being used by the user. The equipment parameter 822 comprises the resolution and the number of colors of a screen 824 on the cellular phone 82. In addition, the data server 81 can acquire a user's friend list 823 from the cellular phone 82 or the community server 84.

After the data server 81 downloads data contents 841 corresponding to the request 821 from the community server 84, the filter 814 can filter off some unnecessary content to effectively decrease the quantity of the data contents 841. Thereafter, according to the equipment parameter 822, the multimedia processing unit 812 determines the multimedia data 842 contained in the data contents 841, for example, the resolution or the number of colors. After that, according to a friend list 823 of the user and a friend list of the owner 843 contained in the data contents 841, the multimedia processing unit 812 determines a level of the closeness between the user and owner. Since the multimedia processing unit 812 determines the level of closeness between the user and the owner in a manner similar to that as described in Table 2, it is not described in details herein. Multimedia processing unit 812 according to the level of closeness determines the final re-arranged value of the multimedia data 842 in the data contents again, and re-arranged in accordance with final re-arranged value for image processing. Finally, the data server 81 via the communication port 811 sends the re-arranged multimedia data 844 to the cellular phone 82. In this way, the cellular phone users can receive a lower amount of data on the community web page information, making browsing speed more smoothly, and the closer friends of multimedia data has higher resolution and more clear content, and to further improve the efficiency of browsing community web page.

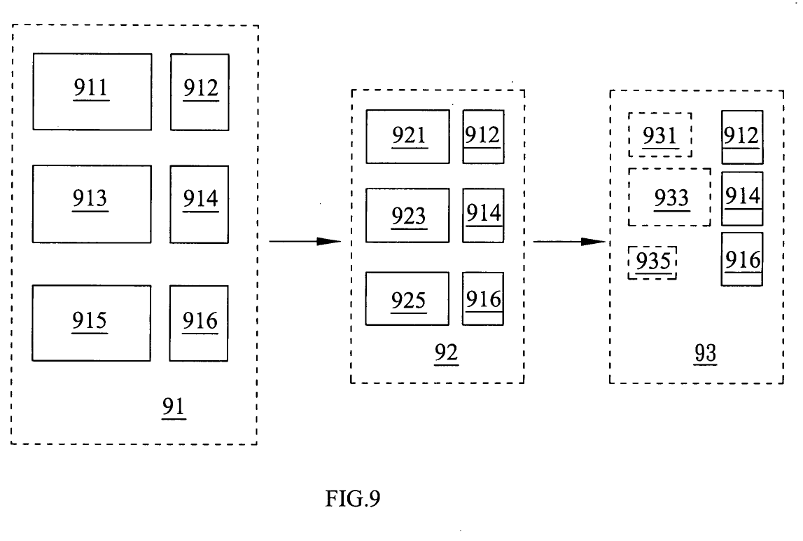

FIG. 9 shows a schematic drawing of re-arranging the multimedia data according to the present invention. As shown, the web contents 91 comprises pictures 911,913 and 915, as well as 912, 914 and 916 correspond to the text, which is the web page of the community web server be designed on the screen for surfing, so the picture 911, 913 and 915 of the web contents have a higher resolution. If the web contents do not re-arranged appropriately, the disadvantages for users is can not effectively surf full page and download data too slowly when the users surf the web page on the cellular phone. Therefore, the data server of the prevent invention is according to the screen parameter to narrow the resolution of the pictures 911, 913 and 915 first, and to produce the pictures 921, 923 and 925. Then, taking into account the users want to see a clear picture of their friends, so the data server re-arranged the resolution and the compression ratio of the picture 921, 923 and 925 once again based on user and a level of closeness of the data owner to generate the pictures 931, 933 and 935. Wherein the picture 933 is the user's friend's picture, so the data server maintain the original resolution and uses low compression ratio for compression, and picture 935 is a friend of a friend of the user picture, so the data server slightly reduce the resolution and compress the picture 931 in the middle compression ratio and the picture 935 of the owner has nothing to do with the users, so the data server in order to reduce the resolution of the picture 935 and compress the picture 935 in high compression ratio. When the user surf the web contents 93 on the cellular phone, the user can watch the friend data more clearly and use the bandwidth more efficiently. Please note that the FIG. 9 use multi-stage to describe the re-arrange process of multimedia data but not be the restriction.

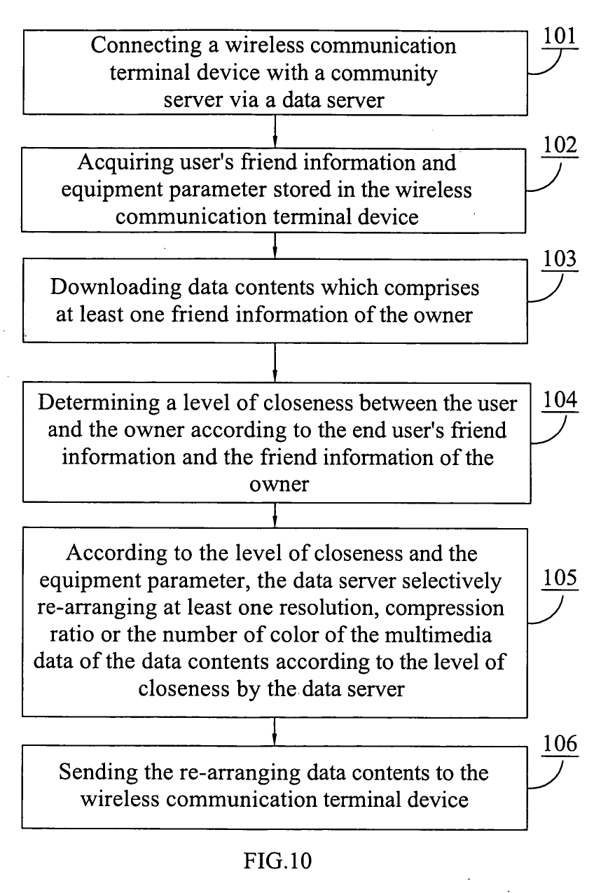

Please refer to FIG. 10, which is a flowchart showing a method of an internet service according to the present invention. The illustrated method allows a user to operate a wireless communication terminal device, such as a cellular phone or a personal digital assistant (PDA), to receive data contents of a community server over the Internet. The method comprises the following steps. In step 101, the user sends out a request at the wireless communication terminal device and the request is then transmitted to a data server via a wireless communication network, and thereby the wireless communication terminal device is connected to a community server over the Internet via the data server. In step 102, equipment parameter and user's friend information stored in the wireless communication terminal device is acquired. In step 103, the data server downloads data contents corresponding to the request from the community server and the data contents corresponding to the request comprises at least one friend information of the owner. In step 104, a level of closeness between the user and the owner is determined according to the user's friend information and the friend information of the owner, as shown in Table 2. In step 105, according to the level of closeness and the equipment parameter, the data server selectively re-arranging at least one resolution, compression ratio or the number of color of the multimedia data of the data contents according to the level of closeness by the data server. Finally, in step 106, the re-arranged data contents are sending to the wireless communication terminal device.

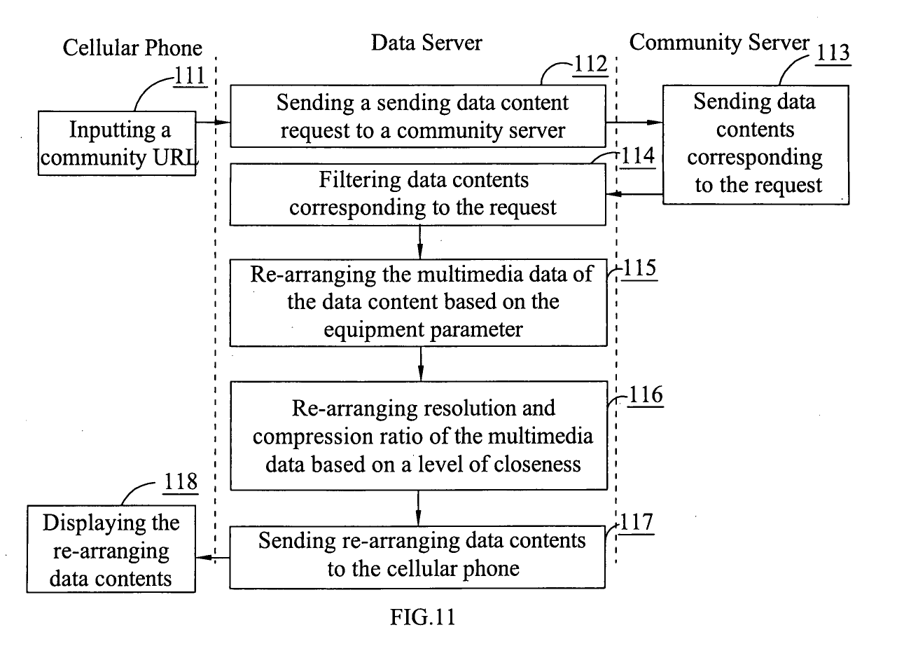

FIG. 11 is a flowchart showing a method of an internet service according to the present invention. In step 111, a user inputs a community URL at a cellular phone, and the request containing the community URL is transmitted to a data server via a wireless network, as well as the equipment parameter. Wherein the equipment parameter of the cellular phone and the request URL information be sent to the data server together, or the equipment parameter of the cellular phone can be pre-sent to the data server, and then connect the demand for the cellular phone have only sent when the request URL. In step 112, after receiving the request, the data server sends a sending data content request to a community server corresponding to the requested community URL over the Internet. In the event the user has not yet logged on the requested community website, the data server can send a logon request to the community server and send user identification information to the community server to complete the logon procedure. In step 113, the community server sends data contents corresponding to the request to the data server. The data contents comprise at least one friend information of the owner. In step 114, the data server filters the received data contents corresponding to the request, so as to filter off extremely small pictures or advertising contents. In step 115, re-arranging the resolution, compression ratio and the number of colors of the multimedia data first time based on the equipment parameter of the cellular phone. In step 116, according to the user's friend information and the friend information of the owner, a level of closeness between the user and the owner is determined, as shown in Table 2, resolution and compression ratio of the multimedia data corresponding to the request are re-arranged according to a level of closeness. In step 117, the re-arranged data contents are sent to the cellular phone. And, finally, in step 118, the re-arranged data contents are displayed on a screen of the cellular phone.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A method of a re-layout of web contents of an internet service of a community server over the Internet, applicable to a wireless communication terminal device for web surfing of a user, the method comprising the following steps:
sending out a request by the wireless communication terminal device and transmitting the request to a data server via a wireless communication network, and thereby connecting the wireless communication terminal device to the community server via the data server;
acquiring the user's friend information stored in the wireless communication terminal device;
downloading web contents corresponding to the request from the community server by the data server, wherein the web contents corresponding to the request comprise at least one object and friend information of the owner of the at least one object;
determining a level of closeness between the user and the object owner according to the user's friend information and the friend information of the object owner;
selectively re-arranging the layout of the web contents according to the level of closeness by the data server; and
sending the re-layout web contents to the wireless communication terminal device.

2. The method as claimed in claim 1, further comprising a step of acquiring an equipment parameter of the wireless communication terminal device, and wherein the data server re-arranges the layout of the web contents based on the equipment parameter and the level of closeness.

3. The method as claimed in claim 1, wherein the object is disposed at an eye-catching location in the layout of the web contents or a location that is more easily observed on a screen of the wireless communication terminal device while the user and the object owner have a closer relationship.

4. A web content re-layout of an internet service system, for a user to surf web contents of a community server, comprising:
a data server coupled to the community server; and
a wireless communication terminal device for the user to input a request thereat; the wireless communication terminal device sending the request to the data server via a wireless communication network, thereby linking the wireless communication terminal device to the community server via the data server; and the wireless communication terminal device sending the user's friend information to the data server;
wherein the data server downloads the web contents corresponding to the request from the community server, in which the web contents comprise at least one object and friend information of the owner of the at least one object; a level of closeness between the user and the object owner is determined according to the user's friend information and the friend information of the object owner; and, according to the level of closeness, the data server selectively re-arranges the layout of the web contents corresponding to the request, and sends the re-layout web contents to the wireless communication terminal device.

5. The system as claimed in claim 4, wherein the wireless communication terminal device further sends an equipment parameter to the data server, and the data server re-arranges the layout of the web contents based on the equipment parameter and the level of closeness.

6. The system as claimed in claim 4, wherein the object is disposed at an eye-catching location in the layout of the web contents or a location that is more easily observed on a screen of the wireless communication terminal device while the user and the object owner have a closer relationship

7. A data server connected to a wireless communication network for a wireless communication terminal device to receive web contents provided by a community server via the data server, the data server comprising:
a receiving unit for receiving user's friend information stored in the wireless communication terminal device; and
a re-layout unit for receiving the web contents provided by the community server, the web contents including at least one object and friend information of the owner of the at least one object, determining a level of closeness between the user and the object owner according to the user's friend information and the friend information of the object owner, and then selectively re-arranging the layout of the received web contents according to the level of closeness.

8. The data server as claimed in claim 7, wherein the receiving unit also receives an equipment parameter of the wireless communication terminal device, and the re-layout unit re-arranges the layout of the received web contents based on the equipment parameter and the level of closeness.

9. The data server as claimed in claim 7, wherein the object is disposed at an eye-catching location in the layout of the web contents or a location that is more easily observed on a screen of the wireless communication terminal device while the user and the object owner have a closer relationship.

10. A method of internet services of a community server over the Internet, applicable to a wireless communication terminal device be applied to receive a data content by a user, the method comprising the following steps:
sending out a request by the wireless communication terminal device and transmitting the request to a data server via a wireless communication network, and thereby connecting the wireless communication terminal device to the community server via the data server;
acquiring the user's friend information stored in the wireless communication terminal device;
downloading data contents corresponding to the request from the community server by the data server, wherein the data contents corresponding to the request comprise at least one friend information of the owner;
determining a level of closeness between the user and the owner according to the user's friend information and the friend information of the owner;
selectively re-arranging at least one multimedia resolution, compression ratio or the number of color of the data contents according to the level of closeness by the data server; and
sending the re-arranged data contents to the wireless communication terminal device.

11. The method as claimed in claim 10, further comprising:
acquiring an equipment parameter of the wireless communication terminal device; and
re-arranging resolution, the number of color or compression ratio of the multimedia data of the data contents according to the equipment parameter by the data server;
wherein the equipment parameter comprises resolution or the number of color of the screen of the wireless communication terminal device.

12. The method as claimed in claim 10, wherein the re-arranged multimedia data has higher resolution and lower compression ratio while the user and the owner have a closer relationship.

13. A internet service system, for a user to surf information contents of a community server, comprising:
a data server coupled to the community server; and
a wireless communication terminal device for the user to input a request thereat; the wireless communication terminal device sending the request to the data server via a wireless communication network, thereby linking the wireless communication terminal device to the community server via the data server; and the wireless communication terminal device sending the user's friend information to the data server;
wherein the data server downloads the data contents corresponding to the request from the community server, in which the data contents comprise at least one friend information of the owner; a level of closeness between the user and the owner is determined according to the user's friend information and the friend information of the owner, the data server selectively re-arranging at least one resolution, compression ratio or the number of color of the multimedia data of the data contents according to the level of closeness, and then the data server sending the data contents to the wireless communication terminal device.

14. The internet service system as claimed in claim 13, wherein the wireless communication terminal device further sends an equipment parameter to the data server, and the data server re-arranging resolution, the number of color or compression ratio of the multimedia data of the data contents based on the equipment parameter.

15. The internet service system as claimed in claim 14, wherein the equipment parameter comprises resolution or the number of color of the screen of the wireless communication terminal device.

16. The internet service system as claimed in claim 13, wherein the re-arranged multimedia data has higher resolution and lower compression ratio while the user and the owner have a closer relationship.

17. A data server connected to a wireless communication network for a wireless communication terminal device to receive a data content provided by a community server via the data server, the data server comprising:
a receiving unit for receiving user's friend information stored in the wireless communication terminal device; and
a multimedia processing unit for receiving the information contents provided by the community server, the data contents including at least one friend information of the owner, determining a level of closeness between the user and the owner according to the user's friend information and the friend information of the owner, and then selectively re-arranging at least one resolution, compression ratio or the number of color of the multimedia data of the data contents according to the level of closeness by the data server.

18. The data server as claimed in claim 17, wherein the receiving unit further receives an equipment parameter from the wireless communication terminal device, and the multimedia processing unit re-arranging resolution, the number of color or compression ratio of the multimedia data of the data contents based on the equipment parameter.

19. The data server as claimed in claim 18, wherein the equipment parameter comprises resolution or the number of color of the screen of the wireless communication terminal device.

20. The data server as claimed in claim 17, wherein the re-arranged multimedia data have higher resolution and lower compression ratio while the user and the owner have a closer relationship.
